(19) United States
(12) Patent Application Publication
(10) Pub. No.: US 2015/0010688 A1
(43) Pub. Date: Jan. 8, 2015

(54) CHEESE-LIKE FOOD ARTICLE

(71) Applicant: FUJI OIL COMPANY LIMITED, Osaka (JP)

(72) Inventors: Setsuo Tsujii, Osaka (JP); Naoki Shirotani, Osaka (JP)

(21) Appl. No.: 14/375,766

(22) PCT Filed: Mar. 30, 2013
(86) PCT No.: PCT/JP2013/059782

§ 371 Date: Jul. 30, 2014

(30) Foreign Application Priority Data
Mar. 30, 2012 (JP) 2012-079692

(51) Int. Cl. A23C 19/08

(52) U.S. Cl. CPC A23C 19/08
USPC 426/582; 426/522; 426/523

(57) ABSTRACT

The present invention aims at providing a cheese-like food product, which has mechanical processing adaptability such as shreddability, is easily melted by heat treatment, and maintains a soft edible texture even after it is cooled down. The inventors of the present invention discovered that a cheese-like food product, which includes acid-treated starch; fat-and-oil, which includes a solid fat content (SFC) of 45 wt % or higher at 10° C. and an SFC of 20 wt % or higher at 20° C.; and a protein in an amount of 10 wt % or less can satisfy the above criteria and thereby completed the present invention.

### FIELD OF THE INVENTION

The present invention relates generally to a cheese-like food product.

### BACKGROUND OF THE INVENTION

Cheese is a kind of food derived from raw milk from cows, water buffalos, sheep, goats, yaks, etc. It is produced by processing such as coagulation or fermentation. Cheese may be eaten alone, or may be consumed with other foods, such as, pizza, pasta, gratin, risotto, cheese fondue, etc. The demand for cheese has been increasing every year.

Because it is cooked with heat mainly when formulated with other foods, cheese desirably melts and is easily spun; characteristics necessary for easy shifting to a paste phase upon heating. In addition, preferred types of cheese exhibit a physical property that accounts for the maintenance of a soft edible texture even when it gets cool.

Among natural cheeses for use in pizzas are mozzarella cheese and Gouda cheese. At a high temperature, these natural cheeses are of high enough spinnability to enter into a sol phase. However, they turn into a hard wax phase, with a consequent significant decrease in both flavor and edible texture, when they are cooled down to room temperature (15-25° C.).

There is also processed cheese that is made from a natural cheese combined with molten salt, emulsifiers, water, and the like by heating and emulsifying. For example, processed cheeses are disclosed in Patent documents 1 and 2, with an emphasis placed upon their good spinnability at high temperatures. All of them become hardened at room temperature (15-25° C.). Since they have a gel of calcium paracaseinate, characteristic of rennet-coagulated cheese, as a backbone, processed cheeses with spinnability at high temperature regions, although in a sol phase under heat, are solidified at room temperature (15-25° C.), and thus fail to exhibit spinnability at room temperature.

This is considered attributable to the fact that the cheese protein calcium paracaseinate turns from an insoluble form to a soluble form of sodium paracaseinate during the cheese processing with an emulsifier, and remains as casein glue.

Accordingly, cheese having a gel of protein as a backbone, like natural cheese or processed cheese, suffers from the drawback of being unable to retain a soft edible texture after being heated.

For use in pizzas or gratin recipes, processed cheese, which is prepared by cutting or slicing of a block-shaped cheese, is generally used because it is readily used or melted upon heating, and thus there is a need for the development of a cheese having processing adaptability to be sufficiently shredded.

Prior Art Documents—Patent Documents:

Japanese Patent Application Publication Sho 62-285755

Japanese Patent Application Publication Hei 2-92239.

### SUMMARY OF THE INVENTION

### Technical Problem

It is an object of the present invention to provide a cheese-like food product which has mechanical processing adaptability such as shreddability and which can be easily melted by heat and retain a soft edible texture even after it is cooled.

### Technical Solution

Leading to the present invention, intensive and thorough research, conducted by the present inventors, resulted in the finding that a cheese-like food product comprising an acid-treated starch, a fat-and-oil with a solid fat content (SFC) of 45 wt % or higher at 10° C. and 20 wt % or higher at 20° C., and a protein in an amount of 10 wt % or less can resolve the problems encountered in the prior art.

More specifically, the present invention aims at providing:

(1) a cheese-like food product comprising an acid-treated starch, a fat-and oil with a solid fat content (SFC) of 45 wt % or higher at 10° C. and 20 wt % or higher at 20° C., and a protein in an amount of 10 wt % or less;

(2) the cheese-like food product described in (1), wherein the fat-and-oil has an open-tube melting point of 25 to 45° C.;

(3) the cheese-like food product described in (1) or (2), further comprising a thickener;

(4) the cheese-like food product described in any one of (1) to (3), having a hardness of 500g-2000 g/19.6 mm² at 5° C., as measured by a rheometer (a circular plunger with a diameter of 5 mm, and a table speed of 50 mm/min, Hudo Industries Ltd., JAPAN);

(5) a molded cheese-like food product in a sliced, diced, rectangular block, or shredded phase, prepared by cutting the cheese-like food product described in any one of (1) to (4);

(6) the molded cheese-like food product described in (5), exhibiting heat meltability sufficient to turn into a paste phase upon heating at 200° C. for 5 minutes; and

(7) a method for continuously producing the cheese-like food product described in any one of (1) to (4), comprising a heat treatment by means of a tube type heat exchanger or a direct steam blowing type sterilizer.

### Advantageous Effect

Provided is a cheese-like food product, which has mechanical processing adaptability such as shreddability and which can be easily melted by heat and retain a soft edible texture even after it is cooled.

### DETAILED DESCRIPTION OF THE INVENTION

Hereinafter, the present invention will be described in detail.

The cheese-like food product of the present invention is characterized in that it includes acid-treated starch. Acid-treated starch refers to a processed starch as a result of the treatment of untreated starch with an acid, such as hydrochloric acid or sulfuric acid. The starch to be used may include those derived from peas, potatoes, tapiocas, rice, waxy corn, corn, etc., and among them, as a raw material for a cheese-like food product in light of mechanical processing adaptability an acid-treated starch derived from peas and potatoes are preferable. In addition, in manufacturing the cheese-like food product, acid-treated starch derived from peas is most preferable in terms of mixed viscosity.

In the present invention, it is preferable that the acid-treated starch be added to the cheese-like food product in an amount of 3-20 wt %, more preferably in an amount of 5-18 wt %, and most preferably in an amount of 8-15 wt %.

The cheese-like food product of the present invention is characterized in that it includes a fat-and-oil with a solid fat content (SFC) of 45 wt % or higher at 10° C., and an SFC of 20 wt % or higher at 20° C. Preferably, the fat-and-oil has an SFC of 50 wt % or higher at 10° C. and an SFC of 25 wt % or higher at 20° C., and more preferably, an SFC of 55 wt % or higher at 10° C., and an SFC of 30 wt % or higher at 20° C. in light of mechanical processing adaptability.

Preferable among the fat-and-oils with an SFC of 55 wt % or higher at 10° C. and 30 wt % or higher at 20° C. are those containing P2O-type triglyceride in an amount of 8% or higher and more preferably in an amount of 10% or higher in light of mechanical processing adaptability of the cheese-like food product. The term P2O (P stands for palmitic acid and O stands for oleic acid)-type triglyceride is not given a limitation to a position isomer of a fatty acid within the triglyceride molecule, but is intended to encompass both 1,3-palmitoyl-2-oleyl glycerin and 1,2-palmitoyl-3-oleyl glycerin. A preferable P2O-type triglyceride may be a palm oil with an intermediate melting point, as obtained by further fractionation of palm olein oil which is obtained from palm oil by fractionation. In addition, the P2O-type triglyceride may be obtained by curing palm oil or by transesterification of a fat-and-oil containing oleic acid or palmitic acid.

For use in the cheese-like food product of the present invention, the fat-and-oil preferably has an open-tube melting point of 20-50° C., more preferably 25-45° C., and most preferably 30-40° C. in terms of flavor and melt-in-the-mouth texture.

Additionally, the cheese-like food product of the present invention preferably comprises fat-and-oil in an amount of 10-50 wt %, more preferably in an amount of 15-45 wt %, and most preferably in an amount of 20-40 wt %. Given the amount range, the fat-and-oil is speculated to form a better crystalline network and to help the aging of acid-treated starch, thereby conferring mechanical processing adaptability to the cheese-like food.

For the purpose of improving flavor, the cheese-like food product of the present invention may include a small amount of the fat-and-oil derived from butter, fresh cream, etc., in addition to a vegetable fat-and-oil. Also, the cheese-like food product may further include a natural cheese and/or a processed cheese. When used in the cheese-like food product, a small amount of a natural cheese and/or a processed cheese may bring about an improvement in flavor.

The protein contained in the cheese-like food product of the present invention may be a vegetable protein such as soybean protein, corn protein, wheat protein, pea protein, etc., or an animal protein such as casein, ovoalbumin, whey protein, gelatin, actin, myosin, silk protein, etc., and also may be a polypeptide, a peptide, or an amino acid. In the cheese-like food product, the protein may be contained preferably in an amount of 10 wt % or less, and more preferably in an amount of 8 wt % or less.

When the amount of the protein in the cheese-like food product exceeds 10 wt %, the mixed viscosity increases during the manufacture of the cheese-like food product, thus making it difficult to manufacture the cheese-like food product

A thickener, if used, may render an improved tackiness to the cheese-like food product. In addition, a thickener can enhance the mechanical processing adaptability of the shredded cheese to which it is applied. As a thickener, processed starch (hydroxypropylated starch), locust bean gum and guar gum may be preferably used.

The cheese-like food product of the present invention may further include an emulsifier in an amount low enough so as to not affect the flavor thereof. No particular limitations may be imposed on the emulsifier. A typical emulsifier known in the art may be used. Examples of the emulsifier include: lecithin, sucrose fatty acid ester, propylene glycol fatty acid ester, sorbitan fatty acid ester, glycerin fatty acid ester, polyglycerin fatty acid ester, various organic acid monoglycerides such as acetic acid monoglyceride, tartaric acid monoglyceride, acetic acid-tartaric acid mixed monoglyceride, citric acid monoglyceride, diacetyl tartaric acid monoglyceride, lactic acid monoglyceride, etc., and polyoxyethylenesorbitan fatty acid ester.

In addition to the emulsifier, other known additives may be employed, including a pH adjuster such as a phosphate. Furthermore, the cheese-like food product of the present invention may further include a flavor, such as milk flavor, cheese flavor, various spices, fruits purees or jams for flavor enrichment; sweeteners such as sucralose, aspartame, stevia, etc. to provide sweetness; and a coloring agent such as β-carotene or paprika pigment, annatto pigment, etc., to render colors. Also, a preservative, such as glycine, sodium acetate, lysoteam, etc., may be used for long-term storage.

The cheese-like food product of the present invention comprises an acid-treated starch, a fat-and-oil with an SFC of 45 wt % or higher at 10° C., and 20 wt % or higher at 20° C., and a protein in an amount of 10 wt % or less. With regard to physical properties, the cheese-like food product preferably has a hardness of 500-2000 g/19.6 mm² as measured at 5° C. by a rheometer (a circular plunger with a diameter of 5 mm, and a table speed of 50 mm/min, Hudo Industries Ltd., JAPAN). Given a hardness of 700-1800 g/19.6 mm², the cheese-like food product may be more preferably suitable for a shredding process.

When provided with the above-illustrated properties, the cheese-like food product of the present invention may exhibit mechanical processing adaptability sufficient to provide a mechanically processed cheese-like food in a cut, sliced, diced, rectangular block, or shredded phase.

Additionally, the cheese-like food product of the present invention is characterized by heat meltability, so that it turns to a paste phase upon heating at 200° C. for 5 minutes. That is, a cheese-like food product with good heat meltability can be provided in accordance with the present invention. The heat meltability may be evaluated by a method described herein below.

The cheese-like food product may be evaluated for its heat meltability by shredding a cheese-like food product into a mechanically processed cheese-like food product having a size of about 30×5×3 mm, placing a filter paper within a heat-resistant circular metal container having an internal diameter of 85 mm and a thickness of 30 mm, placing 10 g of the cheese-like food product on top of the filter paper, adding 1 g of water to the filter paper, and heating the resultant in an oven maintained at 200° C. for 5 minutes.

The cheese-like food product of the present invention may be prepared by, for example, performing a preliminary emulsification, homogenization, sterilization, and cooling of an oil in water emulsion, which includes a fat-and-oil, a dairy material, acid-treated starch, table salt, a pH adjuster, a flavor, and a pigment mixed therein. During the preliminary emulsification, the pH of the oil in water emulsion may be adjusted to pH 3.5-5.7 using an organic acid or alkaline salt, but it may also be adjusted via lactic acid fermentation. Adjusting pH via lactic acid fermentation is performed at 15-45° C. using a lactic acid starter until the pH reaches 3.5-5.7, and preferably pH 4-5.5. When the pH is higher than 5.5 it will lead to poor long term storage. In contrast, when the pH is below 4 it causes a strong sour taste and deteriorates the flavor balance of the food if used as a cheese-like food product. Therefore, it is preferable that the above pH range be maintained Heat sterilization may be employed to gelatinize starch and be preferably performed at 70-95° C.

In the above manufacturing method, the cheese-like food product of the present invention is characterized in that it contains acid-treated starch. Accordingly, it differs from the conventional natural cheese or processed cheese containing a protein gel as a backbone. The heat treatment process is also characterized in that, instead of a batch production, it enables a continuous production via continuous heat treatment via a tube type heat exchanger or a direct steam blowing type sterilizer. Examples of the heat exchanger capable of continuous heat treatment may include scraped-surface heat exchangers, etc.

A better understanding of the present invention may be obtained through the following examples which are set forth to illustrate, but are not to be construed as limiting the scope of the present invention. Furthermore, the parts and % in the examples are all based on weight.

### Example 1

At 55° C., 34 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 12 weight parts of a pea-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heating at 80-90° C., filled in, quickly frozen by a tunnel freezer, and aged in a refrigerator thereafter.

The thus obtained cheese-like food product contained 34 wt % of a fat-and-oil and 1.6 wt % of a protein, and had a pH of 5.4. Also, it was found to have a hardness of 1,000 g/19.6 mm² as measured at 5° C. by a rheometer (a circular plunger with a diameter of 5 mm, and a table speed of 50 mm/min, Hudo Industries, JAPAN). In addition, the cheese-like food product exhibited an excellent mechanical processing adaptability to a shredding process, etc., and an excellent heat meltability when heated at 200° C. for 5 minutes, and maintained a soft texture and a good cheese flavor even after it was cooled.

### Example 2

At 55° C., 34 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 12 weight parts of a potato-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 800 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent mechanical processing adaptability to a shredding process, etc., and an excellent heat meltability when heated at 200° C. for 5 minutes, and also maintained a soft texture and a good cheese flavor even after it was cooled.

### Example 3

At 55° C., 34 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 12 weight parts of a tapioca-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 500 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent mechanical processing adaptability to a shredding process, etc., and an excellent heat meltability when heated at 200° C. for 5 minutes, and also maintained a soft texture and a good cheese flavor even after it was cooled.

### Example 4

At 55° C., 34 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 12 weight parts of a rice-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 700 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent mechanical processing adaptability to a shredding process, etc., and an excellent heat meltability when heated at 200° C. for 5 minutes, and also maintained a soft texture and a good cheese flavor even after it was cooled.

### Example 5

At 55° C., 34 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 12 weight parts of a waxy corn-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 700 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent mechanical processing adaptability to a shredding process, etc., and an excellent heat meltability when heated at 200° C. for 5 minutes, and also maintained a soft texture and a good cheese flavor even after it was cooled.

### Example 6

At 55° C., 34 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 12 weight parts of a corn-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 1,000 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent mechanical processing adaptability to a shredding process, etc., and an excellent heat meltability when heated at 200° C. for 5 minutes, and also maintained a soft texture and a good cheese flavor even after it was cooled.

### Example 7

At 55° C., 32 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 9 weight parts of a pea-derived, acid-treated starch, 6 weight parts of a waxy corn-derived, hydroxypropylated starch, 2 weight parts of a total milk protein, 5 weight parts of a natural cheese, 0.8 weight part of a table salt, 45.2 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 33.5 wt % of a fat-and-oil, 3 wt % of a protein, and had a pH of 5.4. Also, it was found to have a hardness of 1,000 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent mechanical processing adaptability to a shredding process, etc., and an excellent heat meltability when heated at 200° C. for 5 minutes, and also maintained a soft texture and a good cheese flavor even after it was cooled.

### Example 8

At 55° C., 25 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 15 weight parts of a pea-derived, acid-treated starch, 1 weight part of a total milk protein, 1 weight part of a table salt, 58 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 25 wt % of a fat-and-oil, 0.8 wt % of a protein, and had a pH of 5.4. Also, it was found to have a hardness of 800 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent mechanical processing adaptability to a shredding process, etc., and an excellent heat meltability when heated at 200° C. for 5 minutes, and also maintained a soft texture and a good cheese flavor even after it was cooled.

### Example 9

At 55° C., 34 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 12 weight parts of a pea-derived, acid-treated starch, 1 weight part of a table salt, 53 weight parts of water, 1.7 weight parts of a pH adjuster containing lactic acid, 0.1 weight part of a flavor, 1 weight part of an emulsifier, and 0.002 weight part of a pigment were mixed for 10 min, followed by homogenization under 100 kg/cm².

Upon completion of the homogenization, the resulting homogenate was passed through a scraping-type continuous-heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 0 wt % of a protein, and had a pH of 5.4. Also, it was found to have a hardness of 800 g/19.6 mm² as measured at 5° C. by a rheometer (a circular plunger with a diameter of 5 mm, and a table speed of 50 mm/min, Hudo Industries Ltd., JAPAN), an excellent mechanical processing adaptability to a shredding process, etc., and an excellent heat meltability when heated at 200° C. for 5 minutes, and also maintained a soft texture and a good cheese flavor even after it was cooled.

### Example 10

At 55° C., 34 weight parts of a refined palm oil (an SFC of 55 wt % at 10° C., and 27 wt % at 20° C.; a P2O type triglyceride content of 30 wt %; and an open-tube melting point of 37° C.), 12 weight parts of a pea-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 500 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent mechanical processing adaptability to a shredding process, etc., and an excellent heat meltability when heated at 200° C. for 5 minutes, and also maintained a soft texture and a good cheese flavor even after it was cooled.

### Example 11

At 55° C., 34 weight parts of a transesterified fat-and-oil of palm oil and palm kernel oil (an SFC of 48 wt % at 10° C., and 22 wt % at 20° C.; and a P2O type triglyceride content of 8 wt %; and an open-tube melting point of 32° C.), 12 weight parts of a pea-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 500 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent mechanical processing adaptability to a shredding process, etc., and an excellent heat meltability when heated at 200° C. for 5 minutes, and also maintained a soft texture and a good cheese flavor even after it was cooled.

### Comparative Example 1

At 55° C., 34 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 12 weight parts of a potato-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 400 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent heat meltability when heated at 200° C. for 5 minutes, and also maintained a soft texture and a good cheese flavor even after it was cooled. However, it exhibited a bit poor mechanical processing adaptability to a shredding process, etc.

### Comparative Example 2

At 55° C., 34 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 12 weight parts of a rice-derived, hydroxypropylated phosphate crosslinked starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 100 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an extremely poor mechanical processing adaptability such as to a shredding process and an extremely poor heat meltability when heated at 200° C. for 5 minutes.

### Comparative Example 3

At 55° C., 34 weight parts of a salad oil (an SFC of 0 wt % both at 10° C. and 20° C.), 12 weight parts of a pea-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 100 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent heat meltability when heated at 200° C. for 5 minutes, and also maintained a soft texture and a good cheese flavor even after it was cooled. However, it exhibited an extremely poor mechanical processing adaptability to a shredding process, etc.

### Comparative Example 4

At 55° C., 34 weight parts of a fat-and-oil (an SFC of 47 wt % at 10° C., and 17 wt % at 20° C.; a P2O type triglyceride content of 5 wt %; and an open-tube melting point of 31° C.), 12 weight parts of a pea-derived, acid-treated starch, 2 weight parts of a total milk protein, 1 weight part of a table salt, 51 weight parts of water, 1.7 weight parts of a pH adjuster containing lactic acid, 0.1 weight part of a flavor, and 0.002 weight part of a pigment were mixed for 10 min, followed by homogenization under 100 kg/cm².

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 34 wt % of a fat-and-oil, 1.6 wt % of a protein, and had a pH of 5.4. Also, it was found to have a hardness of 400 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited excellent heat meltability when heated at 200° C. for 5 minutes, and also maintained a soft texture and a good cheese flavor even after it was cooled. However, it exhibited a bit poor mechanical processing adaptability to a shredding process, etc.

### Comparative Example 5

At 55° C., 25 weight parts of a palm oil fraction with an intermediate melting point (an SFC of 90 wt % at 10° C., and 80 wt % at 20° C.; a P2O type triglyceride content of 65 wt %; and an open-tube melting point of 30° C.), 12 weight parts of a pea-derived, acid-treated starch, 15 weight parts of a total milk protein, 1 weight part of a table salt, 47 weight parts of water, 1.7 weight parts of a pH adjuster containing lactic acid, 0.1 weight part of a flavor, and 0.002 weight part of a pigment were mixed for 10 min, followed by homogenization under 100 kg/cm².

(However, its manufacture was difficult because of the high viscosity of the mixture.)

Upon completion of the homogenization, the resulting homogenate was passed through a scraped-surface heat exchanger, sterilized by heat at 80-90° C., filled in, quickly frozen using a tunnel freezer, and aged in a refrigerator thereafter.

The thus obtained cheese-like food product contained 25.2 wt % of a fat-and-oil, 12.2 wt % of a protein, and had a pH of 5.4. Also, it was found to have a hardness of 1,800 g/19.6 mm² as measured at 5° C. by a rheometer (a circular plunger with a diameter of 5 mm, and a table speed of 50 mm/min, Hudo Industries Ltd., JAPAN). In addition, the cheese-like food product exhibited an excellent mechanical processing adaptability to a shredding process, etc., and an excellent heat meltability when heated at 200° C. for 5 minutes. However, it failed to exhibit good softness being turned into a hard wax phase after it was cooled.

It is to be understood that the above-described embodiments are illustrative of only a few of the many possible specific embodiments which can represent applications of the principles of the invention. Numerous and varied other arrangements can be readily devised by those skilled in the art without departing from the spirit and scope of the invention.

1. A cheese-like food product comprising,
acid-treated starch;
a fat-and-oil having a solid fat content (SFC) of 45 wt % or higher at 10° C., and an SFC of 20 wt % or higher at 20° C.; and
a protein in an amount of 10 wt % or less.

2-7. (canceled)

8. The cheese-like food product according to claim 1, wherein the fat-and-oil has an open-tube melting point of 25-45° C.

9. The cheese-like food product according to claim 1, wherein the food product further comprises a thickener.

10. The cheese-like food product according to claim 8, wherein the food product further comprises a thickener.

11. The cheese-like food product according to claim 1, wherein the food product has a hardness of 500˜2000 g/19.6 mm2 as measured at 5° C. by a rheometer (a circular plunger with a diameter of 5 mm, and a table speed of 50 mm/min, Hudo Industries Ltd., JAPAN).

12. The cheese-like food product according to claim 8, wherein the food product has a hardness of 500˜2000 g/19.6 mm2 as measured at 5° C. by a rheometer (a circular plunger with a diameter of 5 mm, and a table speed of 50 mm/min, Hudo Industries Ltd., JAPAN).

13. The cheese-like food product according to claim 9, wherein the food product has a hardness of 500˜2000 g/19.6 mm2 as measured at 5° C. by a rheometer (a circular plunger with a diameter of 5 mm, and a table speed of 50 mm/min, Hudo Industries Ltd., JAPAN).

14. A molded cheese-like food product in a sliced, diced, rectangular block or shredded phase formed by cutting the cheese-like food product according to claim 1.

15. A molded cheese-like food product in a sliced, diced, rectangular block or shredded phase formed by cutting the cheese-like food product according to claims 8.

16. A molded cheese-like food product in a sliced, diced, rectangular block or shredded phase formed by cutting the cheese-like food product according to claims 9.

17. A molded cheese-like food product in a sliced, diced, rectangular block or shredded phase formed by cutting the cheese-like food product according to claims 10.

18. The molded cheese-like food product according to claim 14, wherein the food product provided with heat meltability turns into a paste phase by heating at 200° C. for 5 minutes.

19. The molded cheese-like food product according to claim 15, wherein the food product provided with heat meltability turns into a paste phase by heating at 200° C. for 5 minutes.

20. The molded cheese-like food product according to claim 16, wherein the food product provided with heat meltability turns into a paste phase by heating at 200° C. for 5 minutes.

21. The molded cheese-like food product according to claim 17, wherein the food product provided with heat meltability turns into a paste phase by heating at 200° C. for 5 minutes.

22. A method of continuous production of a cheese-like food product according to claim 1, wherein heat treatment is performed by means of a tube type heat exchanger or a direct steam blowing type sterilizer.

23. A method of continuous production of a cheese-like food product according to claim 8, wherein heat treatment is performed by means of a tube type heat exchanger or a direct steam blowing type sterilizer.

24. A method of continuous production of a cheese-like food product according to claim 9, wherein heat treatment is performed by means of a tube type heat exchanger or a direct steam blowing type sterilizer.

25. A method of continuous production of a cheese-like food product according to claim 10, wherein heat treatment is performed by means of a tube type heat exchanger or a direct steam blowing type sterilizer.
